(19) United States
(12) Patent Application Publication
(10) Pub. No.: US 2003/0128544 A1
(43) Pub. Date: Jul. 10, 2003

(54) Ornamental light with a light converging structure to enhance brightness of the ornamental light

(76) Inventor: George Tsai, Taipei (TW)

Correspondence Address: BACON & THOMAS, PLLC, 625 SLATERS LANE, FOURTH FLOOR, ALEXANDRIA, VA, 22314

(21) Appl. No.: 10/035,237

(22) Filed: Jan. 4, 2002

(51) Int. Cl. F21V 1/00

(52) U.S. Cl. 362/291; 362/292; 362/806

(57) ABSTRACT

An ornamental light casing includes side walls, a convex layer securely engaged with the side walls and a top face corresponding to the convex layer. The convex layer is provided to converge the light from the filament so that the illumination effect of the ornamental light is enhanced.

### BACKGROUND OF THE INVENTION

1. Field of the Invention

The present invention relates to an ornamental light, and more particularly to an ornamental light with a light converging structure to enhance brightness of the ornamental light so as to increase the illumination effect of the ornamental light.

2. Description of Related Art

With reference to FIG. 3, a conventional ornamental light has a bulb (6), a bulb socket (7) and a lampholder (8).

The bulb (6) is received in the socket (7) and then the socket (7) together with the bulb (6) is received in the lampholder (8). It is well known in the art that after dumet wire (61) of the bulb (6) are electrically connected to a power source, the bulb (6) is able to emit light through the casing (62).

With reference to FIG. 4, within the casing (62) of the bulb (6), a filament (63) is provided to that after the dumet wire (61) are electrically connected to the power source, the filament (63) generates heat and light. The light not only penetrates side walls of the casing (62), it also penetrates through a distal end of the casing (62). It is noted from the drawing that the side walls of the conventional casing (62) are all flat, which causes the light from the filament (63) to be refracted. Because of the light refraction caused by the flat side walls of the casing (62), the light from the filament (63) is scattered, therefore, the brightness from this conventional light can only be seen within a certain distance.

To overcome the shortcomings, the present invention tends to provide an improved ornamental light structure to mitigate and obviate the aforementioned problems.

### SUMMARY OF THE INVENTION

The primary objective of the present invention is to provide an ornamental light with a magnifying structure so as to enhance the brightness of the light.

In order to accomplish the foregoing objective, the ornamental light has a convex top layer formed on a distal end of the casing of the ornamental light so that the light from the filament is able to be converged and sent out of the casing in a narrower band when compared with a light beam from a conventional ornamental light casing.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view of a casing of the bulb of the present invention;

FIG. 2 is a cross sectional view of the casing of a still another embodiment of the present invention;

FIG. 3 is an exploded perspective view of a conventional ornamental light; and

FIG. 4 is a cross sectional view of the casing of a conventional ornamental light in FIG. 4.

### DETAILED DESCRIPTION OF THE PREFERRED EMBODIMENT

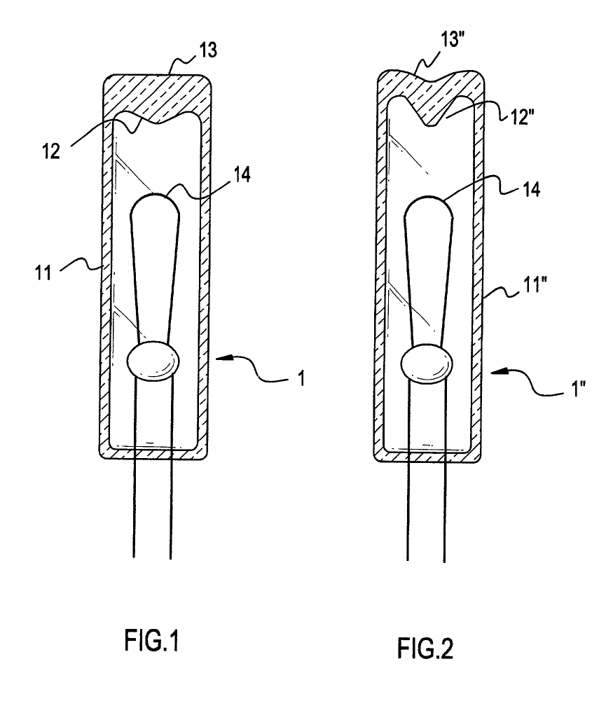

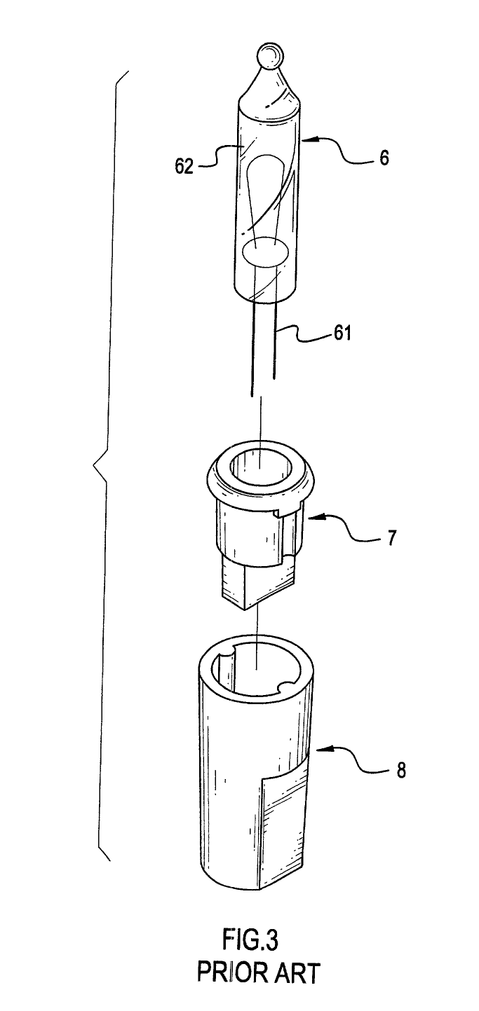

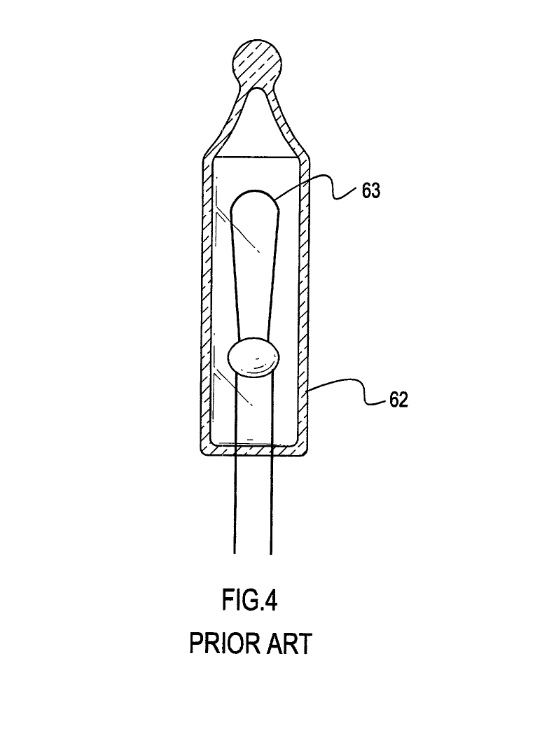

With reference to FIG. 1, a casing (1) of the ornamental light of the present invention has side walls (11) and a convex layer (12) formed on a distal end of the casing (1) to securely engage with the flat side walls (11). The convex layer (12) is incorporated with a flat top wall (13) that is corresponding to the convex layer (12) so that the light from the filament (14) of the ornamental light is able to be converged and thus the illumination effect is enhanced.

With reference to FIG. 2, the ornamental light of the present invention has side walls (11″) and a first convex layer (12″) formed on a distal end of the casing (1″) to securely engage with the flat side walls (11″). The first convex layer (12″) is incorporated with a second convex top wall (13″) that is corresponding to the convex layer (12″) so that the light from the filament (14) of the ornamental light is able to be converged and thus the illumination effect is enhanced.

With the convex layer in the casing of the present invention, the light from the filament is able to be converged and emitted to a further distance when compared with a conventional casing of an ornamental light.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ornamental light casing adapted to receive therein filament to enhance brightness, the casing comprising:
side walls;
a convex layer formed on an inner face of the casing to securely engage with the side walls; and
a flat top wall formed on an outer face of the casing to correspond to the convex layer to converge light from the filament.

2. An ornamental light casing adapted to receive therein filament to enhance brightness, the casing comprising:
side walls;
a first convex layer formed on an inner face of the casing to securely engage with the side walls; and
a second convex top wall formed on an outer face of the casing to correspond to the first convex layer to converge light from the filament.
